(19) United States
(12) Patent Application Publication
(10) Pub. No.: US 2013/0050087 A1
(43) Pub. Date: Feb. 28, 2013

(54) MULTI-FUNCTIONAL MOUSE ASSEMBLY AND INPUT OPERATION METHOD THEREOF

(71) Applicants: YAO-WEN TIEN, Tu-Cheng (TW); JIE LIU, Shenzhen City (CN); MING LI, Shenzhen City (CN); I-WEI FANG, Tu-Cheng (TW); ZHEN-WEI XU, Shenzhen City (CN); JUN LI, Shenzhen City (CN); MENG-XIN WU, Shenzhen City (CN); LI-FENG SHAO, Shenzhen City (CN); WEN-HUA CHEN, Shenzhen City (CN); YUAN-TAO GUO, Shenzhen City (CN); SHEN-KANG LI, Shenzhen City (CN); XIAO-JUN ZHOU, Shenzhen City (CN)

(72) Inventors: YAO-WEN TIEN, Tu-Cheng (TW); JIE LIU, Shenzhen City (CN); MING LI, Shenzhen City (CN); I-WEI FANG, Tu-Cheng (TW); ZHEN-WEI XU, Shenzhen City (CN); JUN LI, Shenzhen City (CN); MENG-XIN WU, Shenzhen City (CN); LI-FENG SHAO, Shenzhen City (CN); WEN-HUA CHEN, Shenzhen City (CN); YUAN-TAO GUO, Shenzhen City (CN); SHEN-KANG LI, Shenzhen City (CN); XIAO-JUN ZHOU, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/303,388

(22) Filed: Nov. 23, 2011

(30) Foreign Application Priority Data
Aug. 31, 2011 (CN) 201110255052.X

(51) Int. Cl. G06F 3/033

(52) U.S. Cl. 345/166; 345/163

(57) ABSTRACT

A mouse assembly used for a computer includes a first mouse module and a second mouse module. The first mouse module includes a first connector, and the second mouse module includes a second connector. The second mouse module is detachably and electrically connected to the first mouse module through the first connector and the second connector. When the first connector is mechanically and electrically connected to the second connector, the first mouse module and the second mouse module are assembled together, and the mouse assembly is used as a wireless mouse. When the first connector is mechanically disconnected from the second connector, the first mouse module intercommunicates with the second mouse module, and the mouse assembly is used as touch input device.

### BACKGROUND

1. Technical field

The disclosure generally relates to mechanical devices, and particularly to a mouse assembly and an input operation method of the mouse assembly.

2. Description of the Related Art

Mouse assemblies used as inputting devices are usually substituted by touch pads on laptops. However, quite a lot of users prefer to use a mouse assembly rather than a touch pad. What is needed is to decrease the size of the mouse assembly having the same function as the touch pad.

Therefore, there is room for improvement within the art.

### BRIEF DESCRIPTION OF THE DRAWINGS

Many aspects of a multi-function mouse assembly and an input operation method thereof can be better understood with reference to the following drawings. The components in the drawings are not necessarily drawn to scale, the emphasis instead being placed upon clearly illustrating the principles of the multi-function mouse assembly and the input operation method thereof. Moreover, in the drawings, like reference numerals designate corresponding parts throughout the several views. Wherever possible, the same reference numbers are used throughout the drawings to refer to the same or like elements of an embodiment.

FIG. 1 is a schematic view of one embodiment of a multi-function mouse assembly including a first mouse module and a second mouse module assembled with the first mouse module of the disclosure.

FIG. 2 is a schematic view of the multi-function mouse assembly shown in FIG. 1 of the disclosure, but from another angle.

FIG. 3 is a schematic view of the multi-function mouse assembly shown in FIG.

1, but the first mouse module disassembled from the second mouse module of the disclosure.

FIG. 4 is a block view of the multi-function mouse assembly shown in FIG. 1 of the disclosure.

FIG. 5 is flowchart of an input operation method for executing control or dimensional input, according to an embodiment of the disclosure.

FIG. 6 is schematic view of illustrating the mouse operating on a supporting surface of a screen.

### DETAILED DESCRIPTION

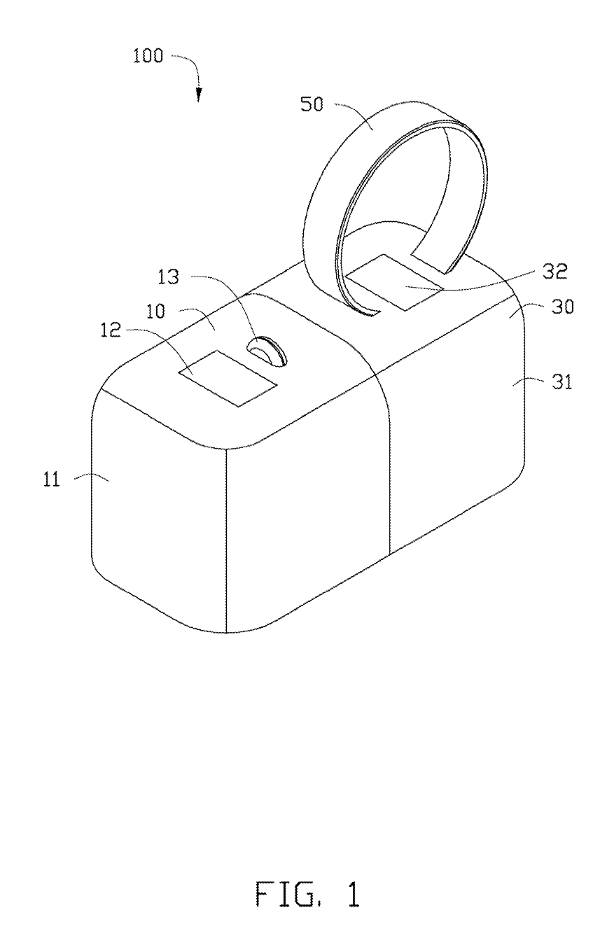

FIG. 1 shows a schematic view of one embodiment of a multi-function mouse assembly 100 including a first mouse module 10 and a second mouse module 30 assembled with the first mouse module 10 of the disclosure. The mouse assembly 100 further includes a ring member 50. In this embodiment, the first mouse module 10 is detachably connected to the second mouse module 30.

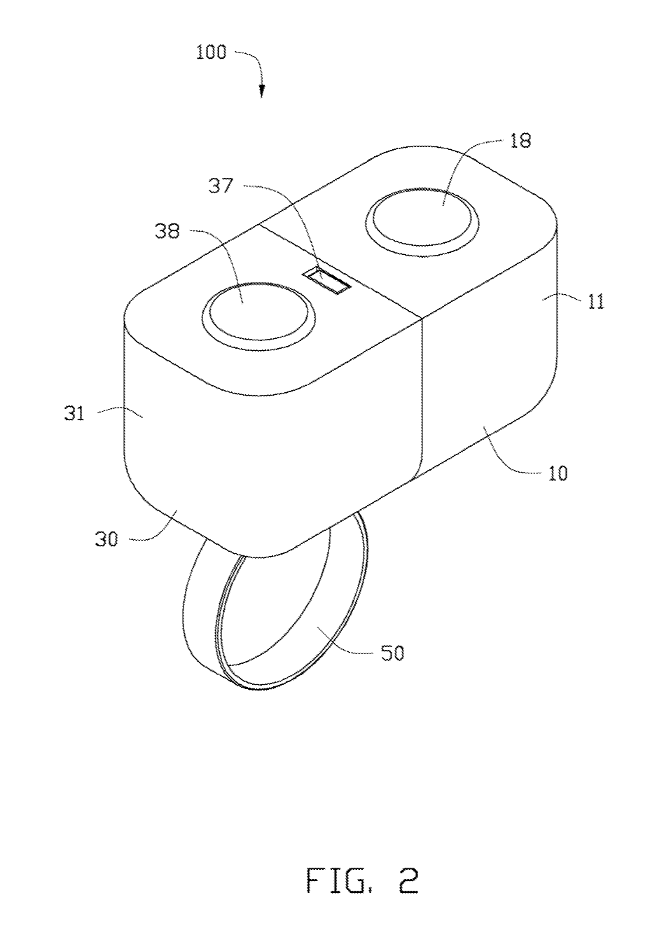

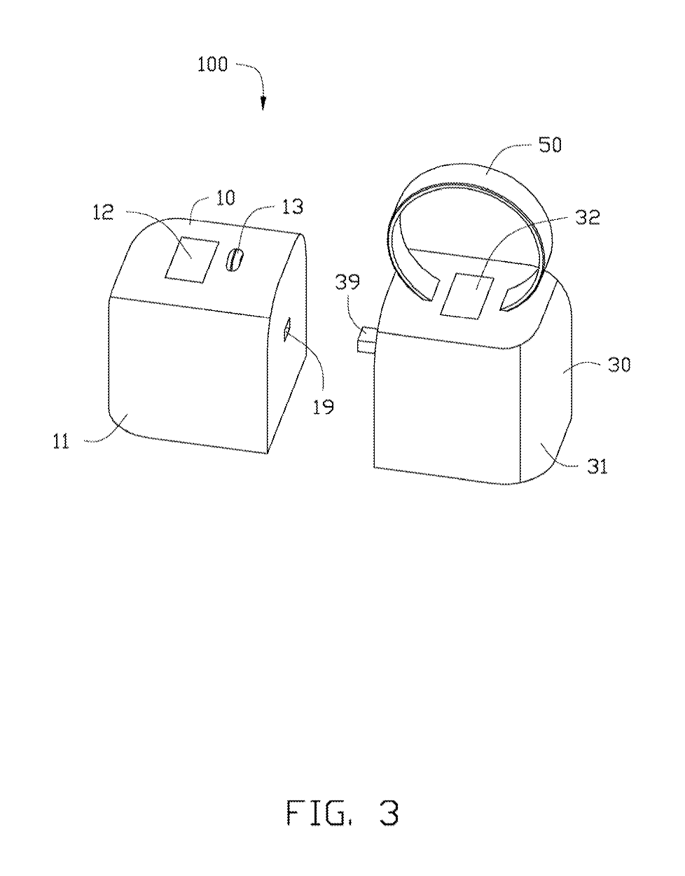

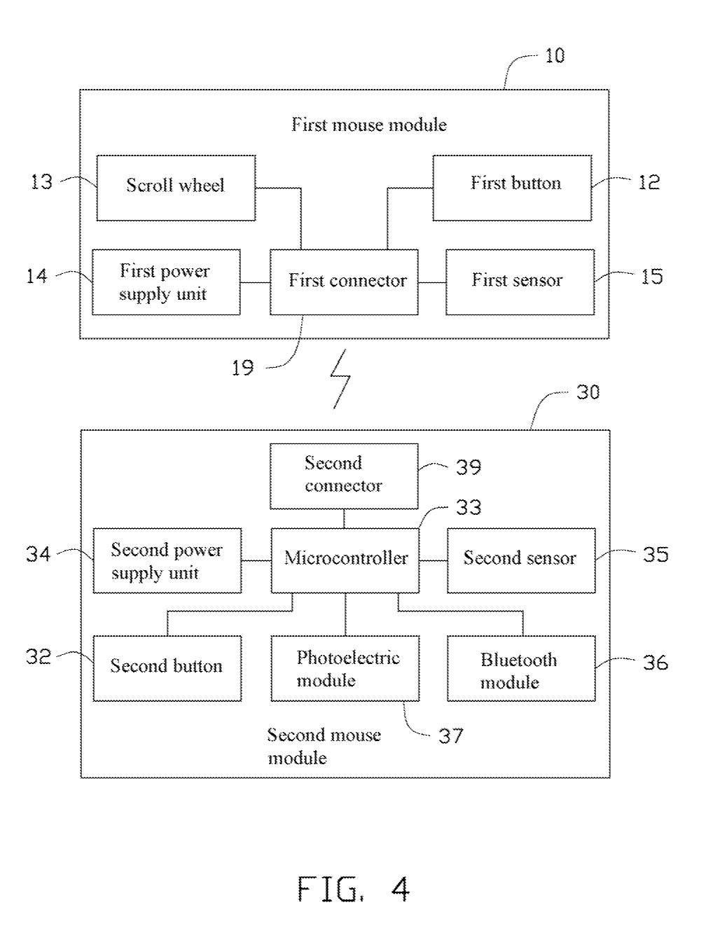

Referring to FIGS. 2-4, the first mouse module 10 includes a first main body 11, a first button 12, a scroll wheel 13, a first power supply unit 14, a first sensor 15, a first sliding pad 18, and a first connector 19. In this embodiment, the first button 12 is exposed out from the upper surface of the first main body 11, and may be a microswitch which can be pressed or clicked at least to select or interact with an element of a graphical user interface, like the operation manner of typical mouse assembly. The scroll wheel 13 is located adjacent to the first button 12 and is exposed out from the upper surface of the main body 11. The scroll wheel 13 can be rotatably and partially received within the main body 11 and is substantially perpendicular to the upper surface of the main body 10, for scrolling and may further be used as a supplemental mouse button that can be pressed.

In this embodiment, the first power supply unit 14 is received within the main body 11 to supply power for the first mouse module 10. The first power supply unit 14 can be a dry cell battery or rechargeable battery. When the first power supply unit 14 is a rechargeable battery, during recharging, the first connector 19 is electrically connected to an external power source. The first sensor 15 is a displacement sensor and is located within the main body 11, and is capable of measuring the position and/or changes of the position of the second mouse module 30.

The sliding pad 18 is a layer positioned at the bottom surface of the first main body 11 and enhances the usability of the mouse module 10. In this embodiment, the sliding pad 18 may be made of plastic or rubber. The first connector 19 is located at the surface, facing the second mouse module 30. The first connector 19 is electrically connected to the first button 12, the scroll wheel 13, the first power supply unit 14 and the first sensor 15, and can be a universal serial bus (USB) connector that is used as an electro-mechanical device for joining electrical circuits.

The second mouse module 30 has substantially the same shape as the first mouse module 10, and includes a second main body 31, a second button 32, a microcontroller 33, a second power supply unit 34, a second sensor 35, a BLUETOOTH module 36, a photoelectric module 37, a second sliding pad 38, and a second connector 39. In this embodiment, the microcontroller 33 received in the main body 31 is electrically connected to the second button 32, the second power supply unit 34, the second sensor 35, the BLUETOOTH module 36, the photoelectric module 37 and the second connector 39.

The second button 32 is exposed out from the upper surface of the second main body 31 and may be a micro-switch that can be pressed or clicked to choose or interact with an element of a graphical user interface, like the operation manner of a typical mouse assembly. The microcontroller 33 processes the instructions sent from the mouse assembly 100 and performs the basic arithmetical, logical and input/output operations to control the second button 32, the second sensor 35, the BLUETOOTH module 36, the photoelectric module 37 and the second connector 39. The second power supply unit 34 is received within the main body 31 to power the second mouse module 30. In this embodiment, the second power supply unit 34 can be a dry cell battery or rechargeable battery. When the second power supply unit 34 is needed to be recharged, the second connector 39 electrically connects with an external power source for charging the second power supply unit 34.

The second sensor 35 can be a displacement sensor and is located within the main body 31. The second sensor 35 is in electronic communication with the first sensor 15 to measure and determine the position and/or the displacement of the second mouse module 30 relative to the first mouse module 10. The BLUETOOTH module 36 is capable of transferring information between the mouse assembly 100 and a computer (not shown) such as a laptop. In this embodiment, the photoelectric module 37 is partially exposed out from the bottom surface of the second main body 31 and can be a photoelectric sensor or infrared displacement sensor. The photoelectric module 37 is capable of measuring the position and/or the changes of the position of the mouse assembly 100.

The second sliding pad 38 is located at the bottom surface of the main body 31, and adjacent to the photoelectric module 37, and enhances the usability of the mouse module 30. The second sliding pad 38 is substantially the same as the first sliding pad 18 which is made of plastic or rubber. The second connector 39 can be a USB connector that is used as an electro-mechanical device for joining electrical circuits. In this embodiment, the second connector 39 is detachably and electrically connected to the first connector 19.

The ring member 50 is a substantially circular ring and can be detachably secured to the upper surface of the second mouse module 30 to hold the mouse assembly 100, and user can pass one finger through the ring member 50 and press the second button 32. For example, a middle finger can engage through the ring member 50 to operate the second button 32 acting as a right mouse button, and a forefinger can simultaneously operate the scroll wheel 13 and the first button 12 acting as a left mouse button.

In use, when the first connector 19 is electrically and mechanically connected to the second connector 39, the first mouse module 10 and the second mouse module 30 are assembled as a whole. Thus, the mouse assembly 100 can have the same function of a wireless optical mouse.

When the first connector 19 mechanically detaches from the second connector 39, the first mouse module 10 and the second mouse module 30 are disassembled with each other. At this time, the mouse assembly 100 can be used as a touch input device. In use, the first mouse module 10 is positioned at a corner (e.g., top-left corner) of a screen 200 of the computer, and the second mouse module 30 can be acted as the left mouse button. The first sensor 15 intercommunicates with the second sensor 35, and the corner where the first mouse module 10 is positioned is used as an origin. The second mouse module 30 is removed to reach for four corners of the screen 200 to measure the position and/or the displacement of the second mouse module 30 relative to the first mouse module 10. The microcontroller 33 then generates a simulation coordinate system of the screen 200 according to the position and/or the displacement of the second mouse module 30. Thus, when the second mouse module 30 is moved to touch any point on the screen 200, the microcontroller 33 figures out the position coordinates of the second mouse module 30 relative to the first mouse module 10, and transmits the position coordinates of the second mouse module 30 to the computer via the BLUETOOTH module 36, enabling the cursor of the computer to simultaneously move with the second mouse module 30. Thus, the mouse assembly 100 functions as a touch input device.

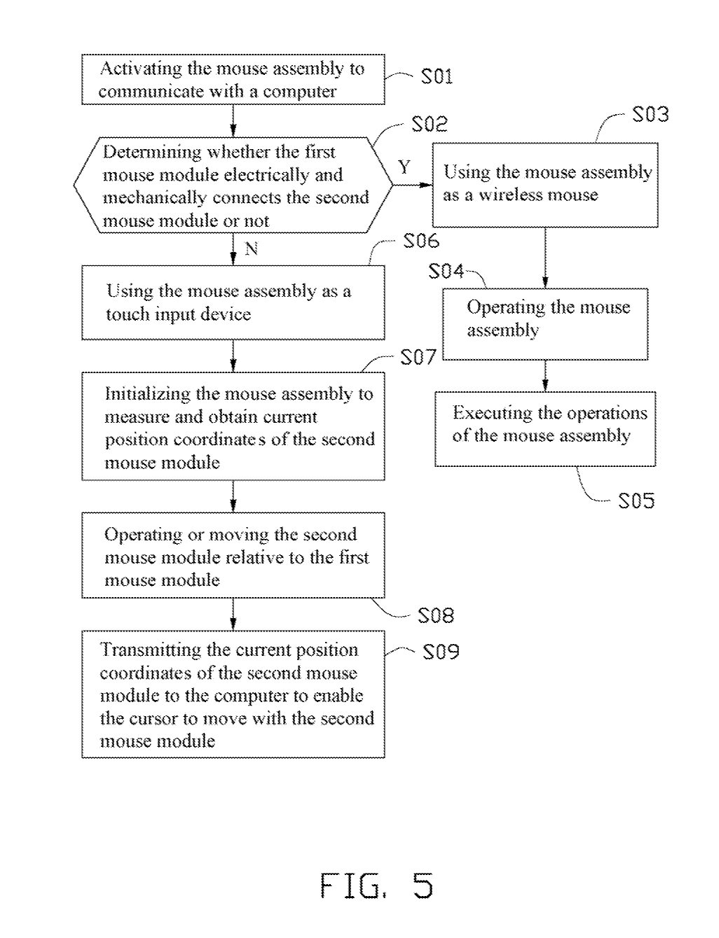

Referring to FIG. 5, an input operation method for executing control or dimensional input according to an embodiment of the disclosure is depicted. The input operation method can use the aforementioned mouse assembly 100, and include at least the following steps.

In step SO1, the mouse assembly 100 is powered on and activated to establish communication with the computer through the BLUETOOTH module 36.

In step S02, the microcontroller 33 determines whether the first mouse module 10 is electrically and mechanically connected to the second mouse module 30. If the first mouse module 10 is electrically and mechanically connected to the second mouse module 30, the method proceeds to step S03; if the first mouse module 10 is disconnected from the second mouse module 30, the method proceeds to step S06.

In step S03, the mouse assembly 100 is used as a wireless mouse, that is, the mouse assembly 100 is in a wireless mouse mode.

In step S04, the microcontroller 36 detects and processes the position and/or the changes of the position of the mouse assembly 100, and input information by the first button 12 and the second button 32.

In step S05, the position and/or the changes of the position of the mouse assembly 100 and the input information are transmitted to the computer from the mouse assembly 100 via the BLUETOOTH module 36 to execute the operations by the first button 12 and/or the second button 32.

In step S06, the mouse assembly 100 is used as a touch input device, that is, the mouse assembly 100 is in a touch input mode.

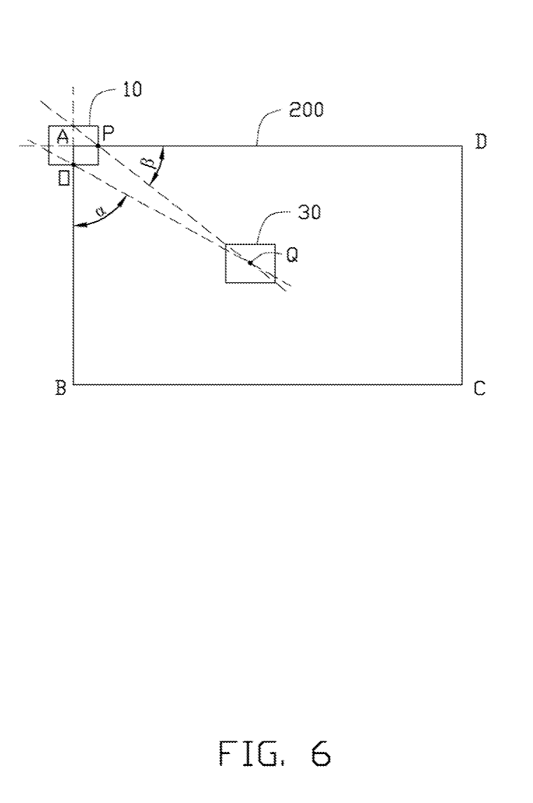

In step S07, the mouse assembly 100 is initialized and enabled to obtain the current position coordinates of the second mouse module 30. Referring to FIG. 6, in this embodiment, the first mouse module 10 is secured at the corner A of the screen 200 by means of magnets or clamp, for example. The position (e.g., the corner A) where the first sensor 15 is positioned is used as the origin of the coordinates, and the first sensor 15 intercommunicates with the second sensor 35. The second mouse module 30 is moved to the corners A, B, C and D of the screen 200 to measure the position and/or the displacement of the second mouse module 30 relative to the first mouse module 10. The microcontroller 33 creates the simulation coordinate system of the screen 200 according to the position and the displacement. The first mouse module 10 has two sensing points O and P, and the second mouse module 30 has a sensing point Q in communication with the sensing points 0 and P. Thus, when the second mouse module 30 touches any point of the screen 200, the second sensor 35 detects the distance between the sensing points O and Q, and the distance between the sensing points P and Q. The microcontroller 33 figures out an included angle a between sides OQ and AB, and an included angle 13 between the sides PQ and AD, and calculates the x-coordinate according to the length of the side OQ and the included angle a, and calculates the y-coordinate according to the length of the side PQ and the included angle 3. Thus, the current displacement of the second mouse module 30 relative to the first mouse module 10 on the screen 200 is measured.

In step S08, the second mouse module 30 is clicked and/or moved relative to the first mouse module 10.

In step S09, the microcontroller 33 transmits the position coordinates of the second mouse module 30 and the input information to the computer in real-time via the BLUETOOTH module 36, to enable the cursor to simultaneously move along with the second mouse module 30 and execute the operation of the second mouse module 30.

Depending on the embodiment, certain of the steps described may be removed, others may be added, and the sequence of steps may be altered. It is also to be understood that the description and the claims drawn for a method may include some indication in reference to certain steps. However, the indication used is only to be viewed for identification purpose and not as a suggestion as to an order for the steps.

In the embodiment of the mouse assembly 100 of the present disclosure, when the first mouse module 10 is electrically and mechanically connected to the second mouse module 30, the mouse assembly as a whole can be treated as a wireless mouse.

When the first mouse module 10 is mechanically disassembled from the second mouse module 30, the mouse assembly 100 can function as a touch input device. The mouse assembly 100 is suitable for a touch screen and other types of display screens, which can meet the requirements of the users.

In the present specification and claims, the word “a” or “an” preceding an element does not exclude the presence of a plurality of such elements. Further, the word “comprising” does not exclude the presence of elements or steps other than those listed.

It is to be understood, however, that even though numerous characteristics and advantages of the exemplary disclosure have been set forth in the foregoing description, together with details of the structure and function of the exemplary disclosure, the disclosure is illustrative only, and changes may be made in detail, especially in the matters of shape, size, and arrangement of parts within the principles of this exemplary disclosure to the full extent indicated by the broad general meaning of the terms in which the appended claims are expressed.

What is claimed is:

1. A mouse assembly used for a computer, the mouse module comprising:
a first mouse module for inputting information to the computer, the first mouse module comprising a first connector; and
a second mouse module for inputting information to the computer, wherein the second mouse module comprises a second connector, the second mouse module is detachably and electrically connected to the first mouse module through the first connector and the second connector, when the first connector is mechanically and electrically connected to the second connector, the first mouse module and the second mouse module are assembled together, and the mouse assembly is used as a wireless mouse; when the first connector is mechanically disconnected from the second connector, the first mouse module intercommunicates with the second mouse module, and the mouse assembly is used as touch input device.

2. The mouse assembly as claimed in claim 1, wherein the first mouse module comprises a first main body and a first button, the first button is exposed out from the upper surface of the first main body, and the first button is a microswitch and is pressed or clicked in order to select or interact with an element of a graphical user interface.

3. The mouse assembly as claimed in claim 2, wherein the first mouse module further comprise a first sensor electrically connected to the first connector, the first sensor is a displacement sensor and is located within the main body, and is capable of measuring the position and/or changes of the position of the second mouse module.

4. The mouse assembly as claimed in claim 2, wherein the first mouse module further comprise a scroll wheel located adjacent to the first button, the scroll wheel is exposed out from the upper surface of the main body and is rotatably and partially received within the main body, the scroll wheel is substantially perpendicular to the upper surface of the main body, and is used for scrolling and used as a third mouse button.

5. The mouse assembly as claimed in claim 4, wherein the first mouse module further comprises a first power supply unit electrically connected to the first connector, the first power supply unit is received within the main body to supply power for the first mouse module, and the first power supply unit is a dry cell battery or rechargeable battery, when the first power supply unit is recharged, the first connector electrically connects an external power source for charging the first power supply unit.

6. The mouse assembly as claimed in claim 3, wherein the second mouse module comprises a second main body and a microcontroller, the microcontroller is located in the second main body and carries out the instructions of the mouse assembly and performs the basic arithmetical, logical and input/output operations.

7. The mouse assembly as claimed in claim 6, wherein the second mouse module further comprises a second sensor located in the second main body, the second sensor is electrically connected to the microcontroller and is in electronic communication with the first sensor to measure and determine the position and/or the displacement of the second mouse module relative to the first mouse module.

8. The mouse assembly as claimed in claim 7, wherein the second mouse module further comprises a BLUETOOTH module located in the second main body, the BLUETOOTH module is electrically connected to the microcontroller, and is capable of transferring information between the mouse assembly and the computer.

9. The mouse assembly as claimed in claim 6, wherein the second mouse module further comprises a photoelectric module, the photoelectric module electrically connects the microcontroller and is partially exposed out from the bottom surface of the second main body, the photoelectric module is a photoelectric sensor or infrared displacement sensor and is capable of measuring the position and/or the changes of the position of the mouse assembly.

10. The mouse assembly as claimed in claim 6, wherein the second mouse module further comprises a second button, the second button is exposed out from the upper surface of the second main body, and the second button is a microswitch and is pressed or clicked in order to select or interact with an element of a graphical user interface.

11. The mouse assembly as claimed in claim 6, wherein the second mouse module further comprises a second power supply unit received within the second main body to provide power for the second mouse module, and the second power supply unit is s dry cell battery or rechargeable battery, when the second power supply unit is recharged, the second connector electrically connects an external power source for charging the second power supply unit.

12. The mouse assembly as claimed in claim 1, further comprising a ring member, wherein the ring member is detachably assembled to the upper surface of the second mouse module to hold and operate the mouse assembly.

13. The mouse assembly as claimed in claim 8, wherein when the first connector is mechanically disconnected from the second connector, the first mouse module is located at one corner of a screen of the computer, and the corner where the first sensor is positioned is used as the origin of the coordinates, the second mouse module is removed to four corners of the screen to measure the position and/or the displacement of the second mouse module relative to the first mouse module, the microcontroller then generates a simulation coordinate system of the screen according to the position and/or the displacement of the second mouse module.

14. The mouse assembly as claimed in claim 13, wherein when the second mouse module touches any point on the screen, the microcontroller figures out the position coordinates of the second mouse module relative to the first mouse module, and transmits the position coordinates of the second mouse module to the computer via the BLUETOOTH module to enable the cursor of the computer to simultaneously move with the second mouse module.

15. A mouse assembly used for a computer, the mouse module comprising:
a first mouse module comprising:
a first sensor; and
a first connector electrically connected to the first sensor; and
a second mouse module comprising:
a microcontroller for carrying out different instructions;
a second sensor electrically connected to the microcontroller and in electronic communication with the first sensor;
a BLUETOOTH module electrically connected to the microcontroller;
a photoelectric module electrically connected to the microcontroller and figuring out the position and changes of the position of the mouse assembly; and
a second connector electrically connected to the microcontroller, wherein the first connector is mechanically and electrically connected or disconnected to the second connector, when the first connector is mechanically and electrically connected to the second connector, the mouse assembly is used as a wireless mouse, the photoelectric module obtains the position information of the mouse assembly, the microcontroller processes position information and transmits processed position information to the computer via the BLUETOOTH module; when the first connector is mechanically disassembled from the second connector, the second sensor measures current position of the second mouse module relative to the first mouse module, and the microcontroller receives and processes the current position of the second mouse module, and transmits processed current position to the computer via the BLUETOOTH module.

16. The mouse assembly as claimed in claim 15, wherein the first mouse module comprises a first main body and a first button, the first sensor is located within the main body, the first connector is located at the surface facing the second mouse module, the first button is exposed out from the upper surface of the first main body, and the first button is a microswitch and is pressed or clicked in order to select or interact with an element of a graphical user interface.

17. The mouse assembly as claimed in claim 16, wherein the first mouse module further comprise a scroll wheel located adjacent to the first button, the scroll wheel is exposed out from the upper surface of the main body and is rotatably and partially received within the main body, the scroll wheel is substantially perpendicular to the upper surface of the main body, and is used for scrolling and used as a third mouse button.

18. The mouse assembly as claimed in claim 15, wherein the second mouse module comprises a second main body and a second button, the microcontroller, the second sensor, the BLUETOOTH module and the photoelectric module are located within the second main body, the second button is exposed out from the upper surface of the second main body, and the second button is a microswitch and is pressed or clicked in order to select or interact with an element of a graphical user interface.

19. The mouse assembly as claimed in claim 15, wherein when the first connector is mechanically disconnected from the second connector, the first mouse module is located at one corner of a screen of the computer, and the corner where the first sensor is positioned is used as the origin of the coordinates, the second mouse module is removed to four corners of the screen to measure the position and/or the displacement of the second mouse module relative to the first mouse module, the microcontroller then generates a simulation coordinate system of the screen according to the position and/or the displacement of the second mouse module.

20. A input operation method for executing control or dimensional input on a screen of a computer, the method comprising steps of:
receiving and decoding the communication protocol to generate a group of identifying messages by a signal controller;
providing a mouse assembly that comprises a first mouse module and a second mouse module, the first mouse module comprising a first sensor, the second mouse module comprising a microcontroller, a button, a second sensor and a BLUETOOTH module;
positioning the first mouse module on the screen as an origin;
moving the second mouse module to four preset points to measure the position and displacement of the second mouse module relative to the first mouse module;
creating a simulation coordinate system of the screen according to the position and displacement of the second mouse module by the microcontroller;
transmitting the simulation coordinate system to the computer through the BLUETOOTH module by the microcontroller;
operating or moving the second mouse module on the screen relative to the first mouse module; and
transmitting current position coordinate of the second mouse module to the computer to enable the cursor to move with the second mouse module.
